(19) United States
(12) Patent Application Publication
(10) Pub. No.: US 2014/0153284 A1
(43) Pub. Date: Jun. 5, 2014

(54) LIGHT SOURCE DEVICE OF BACKLIGHT UNIT FOR DISPLAY

(71) Applicant: FINE DNC CO., LTD., Chungcheongnam-do (KR)

(72) Inventor: Sung Chun Hong, Gyeonggi-do (KR)

(73) Assignee: FINE DNA CO., LTD, Chungcheongnam-do (KR)

(21) Appl. No.: 13/824,200

(22) PCT Filed: Dec. 28, 2012
(86) PCT No.: PCT/KR2012/011733

§ 371 Date: Mar. 15, 2013

(30) Foreign Application Priority Data
Jan. 2, 2012 (KR) 10-2012-0000246

(51) Int. Cl. F21V 29/00; F21V 8/00

(52) U.S. Cl. CPC F21V 29/22; G02B 6/0085
USPC 362/612; 362/97.1

(57) ABSTRACT

A light source device of a backlight unit in which a circuit board on which light-emitting diodes (LEDs) are mounted is disposed inside a rear cover and a heat dissipating means for dissipating heat generated from the LEDs to an outside is disposed between the rear cover and the circuit board. The circuit board is implemented as a patterned substrate which includes a thin sheet and a conductive pattern formed on the thin sheet, the conductive pattern connecting the LEDs to a power source, thereby reducing a thickness through which the heat generated by the LEDs is to be conducted to the heat dissipating means. The heat generated from the LEDs can be more rapidly and efficiently dissipated. Due to the more simplified structure, the light source device can be decreased in weight and be rapidly assembled.

### TECHNICAL FIELD

The present invention relates, in general, to a light source device of a backlight unit for a display.

More particularly, the present invention relates to a light source device in which heat generated from light-emitting diodes (LEDs) of a backlight unit, which is intended to act as a backlight source in a liquid crystal display (LCD) or an LED display, can be more rapidly and efficiently dissipated. At the same time, the light source device has a more simplified structure so that the light source device can be decreased in weight and be rapidly assembled.

### BACKGROUND ART

Illumination using light-emitting diodes (LEDs) involves, for example, lighting equipment and a backlight unit (BLU) for a liquid crystal display (LCD) or an LED display.

A display to which the backlight unit is applied is implemented as an LCD, an LED TV, a computer monitor, or the like. In these displays, a display panel is commonly implemented as an LCD or LEDs in order to display an image, and a backlight unit is disposed in the rear of the display panel. In this construction, the display panel and the backlight unit may then be encased by a front cover and a rear cover and manufactured as a product.

In the backlight unit, a plurality of LEDs acting as an initial light source are mounted on a printed circuit board and disposed at one edge of or directly below a lightguide plate (LGP) which is intended to provide a plane light source. As is well known, a component, such as a lens, is disposed between LEDs and the lightguide plate in order to diffuse light emitted from the LEDs or refract the light in a specific direction.

The LED light source generates a considerable amount of heat during operation, because of the characteristics of LEDs. Such heat becomes an overload factor of the LEDs, and in particular, has adverse effects on LED-driving devices on the PCB. In order to dissipate heat generated by the LEDs to the outside, a heat sink having excellent heat exchange performance is attached to the rear surface of the PCB on which the LEDs are mounted, or a heat dissipation fan is disposed in order to pump heat to the outside.

Korean Patent Application No. 10-2005-0008216 (titled “HEAT DISSIPATION DEVICE FOR LED BACKLIGHT UNIT,” hereinafter, referred to as “the earlier application”) proposed a construction which effectively cools down a backlight of an LCD by dissipating the heat.

More specifically, the heat dissipation device proposed in the earlier application is configured such that the heat sink is coupled to the rear surface of the PCB on which the LEDs are mounted, the resultant structure is connected to a fixing plate, a heat dissipation hole is formed in the fixing plate, and a heat dissipation fan is disposed at a position where the heat dissipation hole is formed in order to pump heat to the outside. In order to improve heat dissipation efficiency, the earlier application is configured such that the PCB is divided into a number of sections each of which corresponds to only one LED among from a number of LEDs, and that a heat pipe is disposed between each PCB section and a corresponding heat sink.

Since the above-described earlier application has a very complicated construction, there are problems in that the manufacturing cost is expensive, and that manufacturing takes a long time, thereby leading to low productivity.

FIG. 1 and FIG. 2 show a light source device of a backlight unit having a heat dissipation construction of the related art, which is intended to overcome the foregoing problems of the heat dissipation device of the earlier application.

This light source device is configured such that a light source unit 4 is disposed inside a rear cover 1 made of a galvanized steel plate (SECC or EGI), and has LEDs 2 mounted on a PCB 3 thereof in order to supply light to a lightguide plate of the backlight unit, and a heat sink 5 made of aluminum is disposed between the PCB 3 of the light source unit 4 and the rear cover 1 in order to transfer heat generated by the LEDs 2 to the rear cover 1 so that the heat is dissipated to the outside.

### DISCLOSURE

### Technical Problem

In the foregoing light source of the backlight unit having the heat dissipation construction of the related art, the heat generated by the LEDs is transferred to the PCB having a considerable thickness and then conducted to a case which is made of a galvanized steel plate having rather low heat conductivity before being dissipated to the outside. Consequently, the heat of the LEDs must undergo a heat conduction process through the considerable thickness of the PCB, the heat sink and the rear cover, thereby exhibiting the problem of significantly-low heat dissipation efficiency.

In addition, the light source device having the triple wall shape of the PCB, the heat sink and the rear cover increases the weight of a product. Furthermore, a series of overlapping fastening constructions increases assembly time and thus lowers productivity, which is problematic.

The present invention has been devised in order to overcome the foregoing problems.

An object of the present invention is to provide a light source device in which heat generated from LEDs of a backlight unit, which is intended to act as a backlight source in an LCD or an LED display, can be more rapidly and efficiently dissipated. At the same time, the light source device has a more simplified structure so that the light source device can be decreased in weight and be rapidly assembled

### Technical Solution

In order to overcome the foregoing object, the present invention is embodied as follows.

In an aspect, the present invention provides a light source device of a backlight unit in which a circuit board on which light-emitting diodes (LEDs) are mounted is disposed inside a rear cover and a heat dissipating means for dissipating heat generated from the LEDs to an outside is disposed between the rear cover and the circuit board. The circuit board is implemented as a patterned substrate which includes a thin sheet and a conductive pattern formed on the thin sheet, the conductive pattern connecting the LEDs to a power source, thereby reducing a thickness through which the heat generated by the LEDs is to be conducted to the heat dissipating means.

In another aspect, the present invention provides a light source device of a backlight unit for a display in which a backlight unit is disposed inside a rear cover. The light source device includes a heat dissipation cover coupled to at least one open portion of the rear cover, the heat dissipation cover forming part of a case construction of the rear cover, and being exposed to an outside, thereby removing a thickness of the rear cover from a thickness through which heat is to be conducted; and a light source unit coupled to an inner surface of the heat dissipation cover at the open portion of the rear cover in order to supply light to a lightguide plate of the backlight unit, the light source unit comprising a patterned substrate and a plurality of LEDs mounted on the patterned substrate

Here, the patterned substrate may include a thin sheet and a conductive pattern formed on the thin sheet, the conductive pattern connecting the LEDs to a power source, thereby reducing a thickness through which the heat generated by the LEDs is to be conducted to the heat dissipation cover. In addition, the patterned substrate may be separately manufactured and attached to the heat dissipation cover or be formed as a substrate layer of a paint which is applied as a coating on a metal surface of the heat dissipation cover. Furthermore, the patterned substrate may be made of a heat conductive plastic which includes a synthetic resin composition and a material mixed to the synthetic resin composition to impart heat conduction ability.

In addition, the heat dissipation cover may form a sidewall surface of the rear cover, and be applied to the backlight unit, the light source device being coupled to an edge the backlight unit. Alternatively, the heat dissipation cover may have at least one section in front of the rear cover, and be applied to the backlight unit, the light source device being disposed directly below the backlight unit.

### Advantageous Effects

As set forth above, the present invention proposes the heat dissipation construction which can dissipate heat generated by the LEDs through minimum conduction. Since the heat generated by the LEDs is more rapidly and efficiently dissipated, it is possible to minimize the malfunction of a product due to the heat.

In addition, according to the present invention, since the LEDs are directly mounted on the rear cover, the construction is simplified and the product is light-weight. Furthermore, due to the simplified construction, the process of assembling the product is more rapidly carried out, thereby improving productivity.

### DESCRIPTION OF DRAWINGS

FIG. 1 is an example view of a light source device of a backlight unit of the related art;

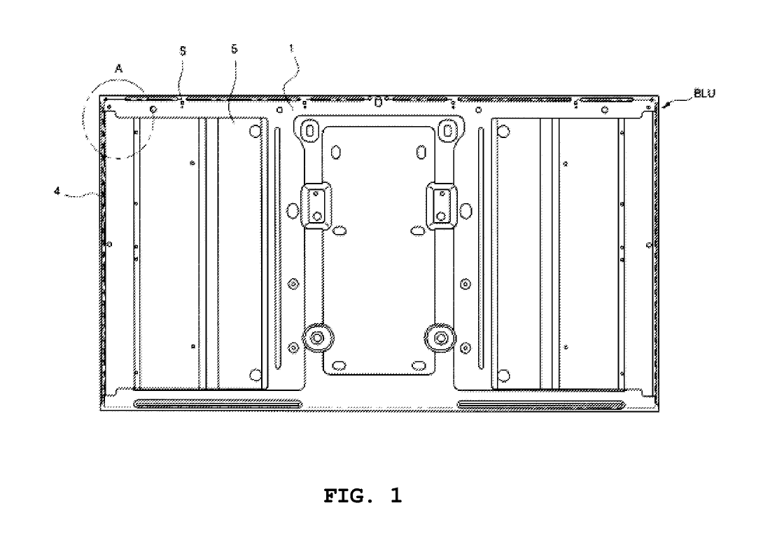

FIG. 2 is an enlarged perspective view of the light source device of a backlight unit of the related art;

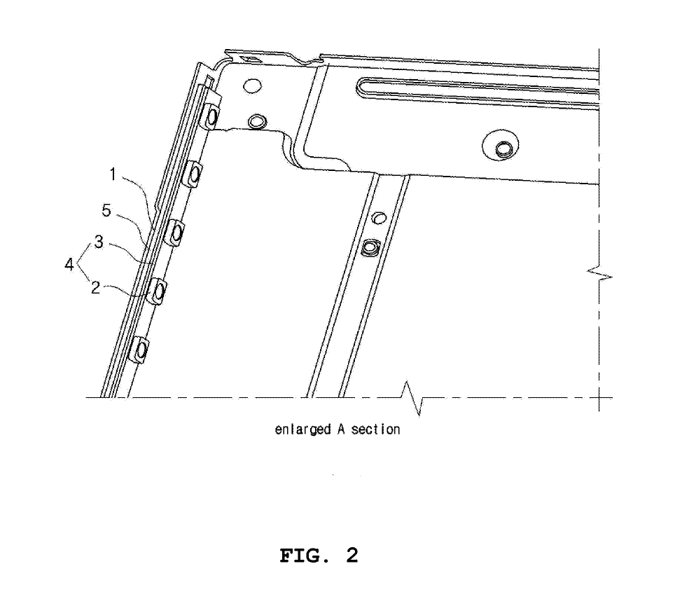

FIG. 3 is an enlarged perspective view of a first embodiment of the present invention;

FIG. 4 is a front elevation view of a second embodiment of the present invention;

FIG. 5 is an enlarged perspective view of the second embodiment of the present invention;

FIG. 6 is an enlarged perspective view of a third embodiment of the present invention; and

FIG. 7 is an enlarged perspective view of a fourth embodiment of the present invention.

<Major Reference Numerals and Symbols of the Drawings>

| | |
|---|---|
| 4010: rear cover | 20: heat dissipation cover |
| 30: light source unit | 31: LED |
| 32: patterned substrate | |

### MODE FOR INVENTION

Hereinafter, embodiments of the present invention will be described in detail with reference to the accompanying drawings.

### FIRST EMBODIMENT

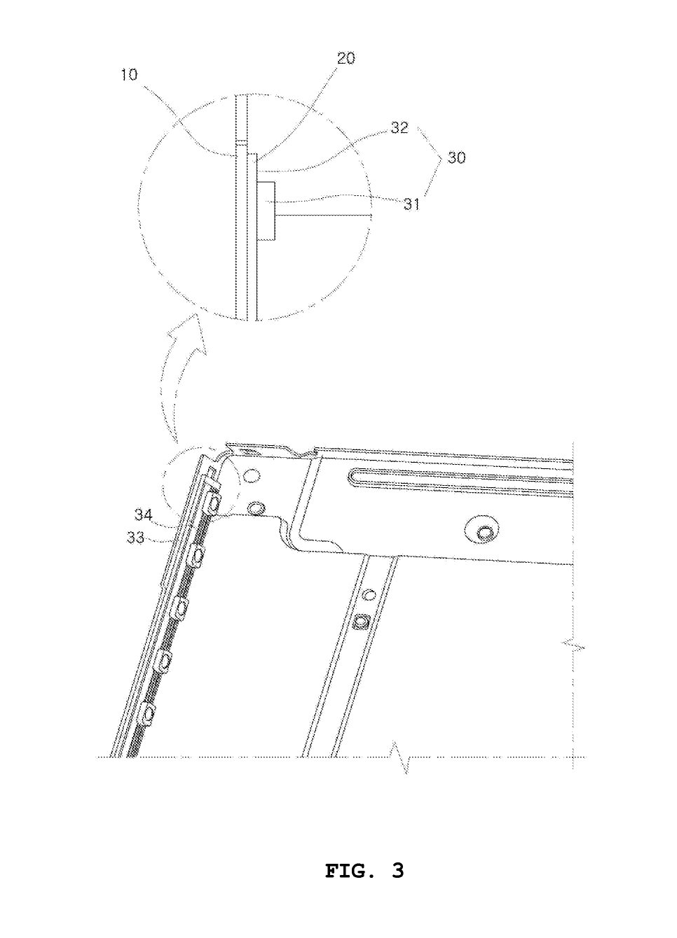

FIG. 3 is an enlarged perspective view of a first embodiment of the present invention.

Referring to the figure, a light source device according to the first embodiment includes a heat dissipation cover 20 and a light source unit 30 which are disposed on a rear cover 10 of a display. Here, the rear cover 10 of the display is illustrated as a rear cover product of an LCD, an LED TV, or the like, and it should be understood that the rear cover 10 can also be applied to a rear cover product of a computer monitor, a display device of a vehicle, or the like.

As is well known, according to this construction, the light source unit 30 has a plurality of LEDs 31 mounted on a circuit board. In order to maximize the efficiency of dissipating heat generated by the LEDs 31, the circuit board which is coupled to the heat dissipation cover 20 is configured as a thin and patterned substrate 32 in order to minimize a thickness through which the heat of the LEDs 31 is conducted before being dissipated to the outside.

For this purpose, the circuit board is configured as a thin and patterned substrate 32 in which a conductive pattern 34 is formed on a thin sheet 33. Consequently, the light source unit 30 is configured such that a plurality of LEDs 31 are mounted on the patterned substrate 32 and that the patterned substrate 32 is coupled with the heat dissipation cover 20 via face-to-face contact. The light source unit 30 is configured such that a suitable number of LEDs 31 are mounted on the patterned substrate 32 in order to supply light to a lightguide plate S of a backlight unit BLU which is coupled to the heat dissipation cover 20 and is disposed inside the rear cover 10.

According to the above-described construction, the light source unit 30 which is implemented with the patterned substrate 32 can exhibit better heat dissipation ability than the light source unit of the related art which is implemented with an FR4 PCB or a metal PCB having a considerable thickness.

### SECOND EMBODIMENT

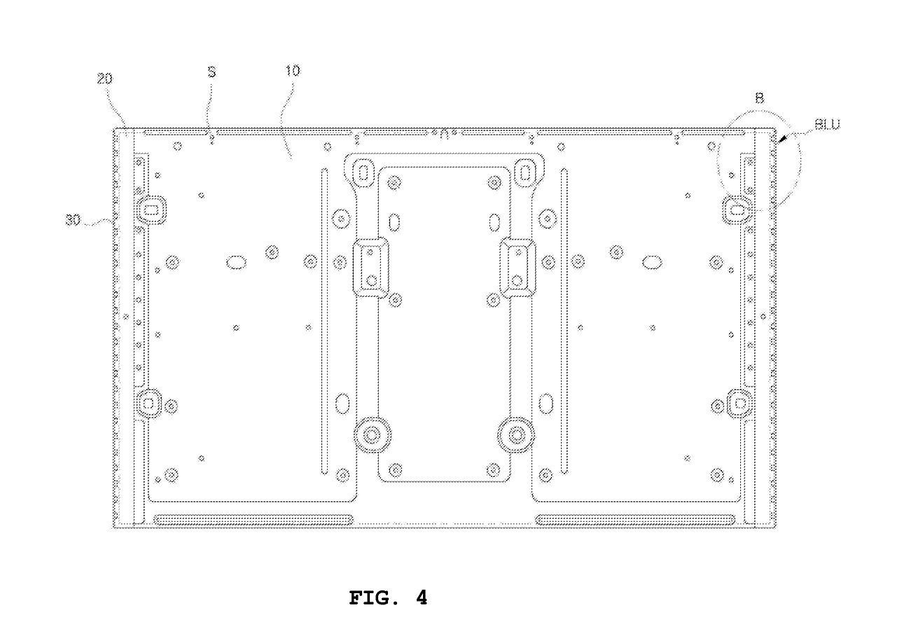

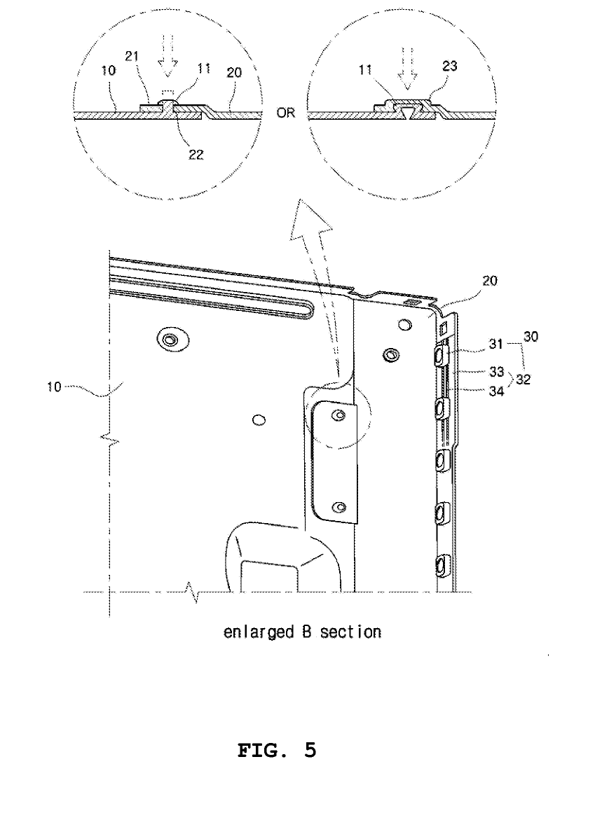

FIG. 4 is a front elevation view of a second embodiment of the present invention, and FIG. 5 is an enlarged perspective view of the second embodiment of the present invention.

Referring to the figures, a light source device according to the second embodiment proposes a construction which can realize heat dissipation ability that more rapidly dissipates heat generated by the LEDs 31 than the first embodiment.

For this, at least one side (both sides in the figures) of the rear cover 10 is open, and the heat dissipation cover 20 is coupled to the open portion of the rear cover 10. Here, the description that the rear cover 10 is open indicates that the wall surface of one or both sides of the rear cover 10 is removed and opened when the light source is coupled to the edge of the backlight unit BLU.

Specifically, the heat dissipation cover 20 is coupled to the open portion of the rear cover 10, and is applied so as to form part of the case construction, specifically, opposite walls of the rear cover 10 according to this embodiment. In this state, the heat dissipation cover 20 is exposed to the outside and is in direct contact with external air. This consequently excludes the thickness of the rear cover 10 from the thickness through which heat generated by the light source unit 30 is to be conducted, thereby significantly reducing the distance involved in heat conduction.

In particular, it is preferred that the heat dissipation cover 20 be made of an aluminum material having excellent heat conductivity. As is well known, the material of the rear cover 10 may be implemented as a galvanized steel plate, such as SECC or EGI, as described above.

In the light source device having the above-described construction, the patterned substrate 32 is configured as a thin plate having a minimum thickness. Specifically, the patterned substrate 32 is configured such that the conductive pattern 34 which electrically connects the plurality of LEDs 31 to a power source is formed on the thin sheet 33.

The patterned substrate 32 is constructed by separately manufacturing the thin sheet 33, forming the conductive pattern 34 on the thin sheet 33, and attaching the thin sheet 33 to the heat dissipation cover 20. Alternatively and more preferably, in the patterned substrate 32, the thin sheet 33 is formed as a substrate layer of a paint material applied on the surface of the heat dissipation cover 20, and a conductive pattern is printed as a coating on the surface of the thin sheet 33.

In particular, the thin sheet 33 of the patterned substrate 32 can be manufactured with excellent heat conduction performance in order to rapidly transfer heat of the LEDs 31 to the heat dissipation cover 20. For this, the thin sheet 33 is implemented as heat conductive plastic. In an example, the heat conductive plastic can be manufactured by dispersing heat conductive particles of a heat conductive material, such as nonferrous oxide or carbon nanotube (CNT), to a high molecular synthetic resin (preferably, a silicone resin) during the manufacture of the thin sheet.

Briefly, the heat dissipation device according to the second embodiment proposes a more simplified construction in which the heat dissipation cover 20 is coupled to the open portion of the rear cover 10 without an overlapping portion.

For this, the rear cover 10 is configured such that its opposite sides are cut to be a certain length (i.e. a length corresponding to the width of the heat dissipation cover, which is required for the construction of the case to be completed by the heat dissipation cover). In addition to this, the heat dissipation cover 20 has a coupling portion 21 which protrudes toward the cut end of the rear cover 10, and is coupled to the rear cover 10 by overlapping the coupling portion 21 over the rear cover 10.

This construction prevents the heat that has been transferred from the LEDs 31 through the heat dissipation cover 20 from being isolated from the outside by the rear cover 10 (this means that the overlapping portion is minimized), so that the heat transferred to the heat dissipation cover 20 performs direct heat exchange with external air, thereby achieving better heat dissipation ability.

In addition, the constructions depicted inside circles in the figure are illustrative constructions in which the rear cover 10 and the heat dissipation cover 20 are coupled with each other. Specifically, a coupling protrusion 11 is formed on the rear cover 10 and a coupling hole 22, or a receptacle 23 is formed in the corresponding portion of the heat dissipation cover 20. Here, the coupling construction is realized by riveting or pressing the coupling protrusion 11 into the coupling hole 22 or the receptacle 23.

In addition, as a most simplified construction for coupling the rear cover 10 and the heat dissipation cover 20 with each other, a separate fastening member can be used to couple the rear cover 10 and the heat dissipation cover 20 with each other. Here, the fastening member can be implemented as a member, such as a bolt or a rivet.

### THIRD EMBODIMENT

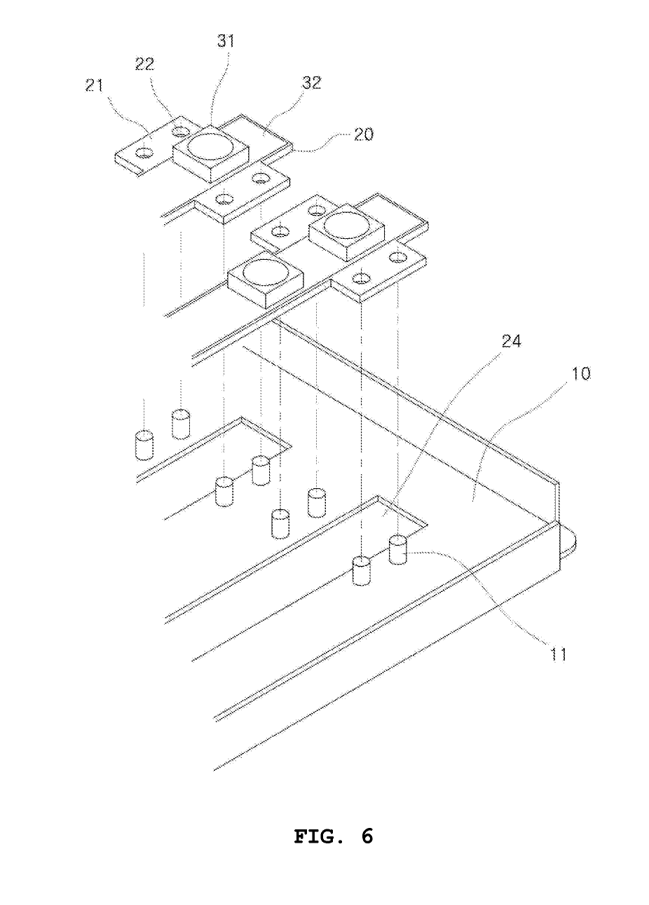

FIG. 6 is an enlarged perspective view of a third embodiment of the present invention.

Referring to the figure, a light source device according to the third embodiment proposes a construction which is employed when the light source is disposed directly below the backlight unit BLU.

For this, the light source device is configured such that a plurality of patterned substrates 32, on each of which a plurality of LEDs 31 are mounted, are disposed on the front surface of the rear cover 10, and the patterned substrates 32 are respectively coupled to a plurality of heat dissipation covers 20, which are then coupled to the rear cover 10.

The rear cover 10 has heat dissipation windows 24 in the front surface thereof, at positions where the heat dissipation covers 20 are to be coupled to the rear cover 10. The heat dissipation windows 24 allow the inside of the rear cover 10 to communicate with the outside, such that the heat dissipation covers 20 are exposed to the outside and perform direct heat exchange with the external air.

In the light source device having the above-described construction, the lightguide plate S is disposed in front of the LEDs 31, thereby providing the backlight unit BLU with the light source being disposed directly below. In particular, although the patterned substrates 32 of the light source unit 30 are illustrated as being arranged in the shape of a plurality of stripes, it is possible to employ a single patterned substrate on which a plurality of LEDs 31 are mounted in a plurality of columns and rows.

Here, considering heat dissipation ability and compatibility with the backlight unit BLU which has the light source disposed directly below, the construction of the light source unit 30 having the patterned substrates 32 which are arranged in the shape of a plurality of stripes is more preferable than the construction of the light source unit 30 having the single patterned substrate 32.

### FOURTH EMBODIMENT

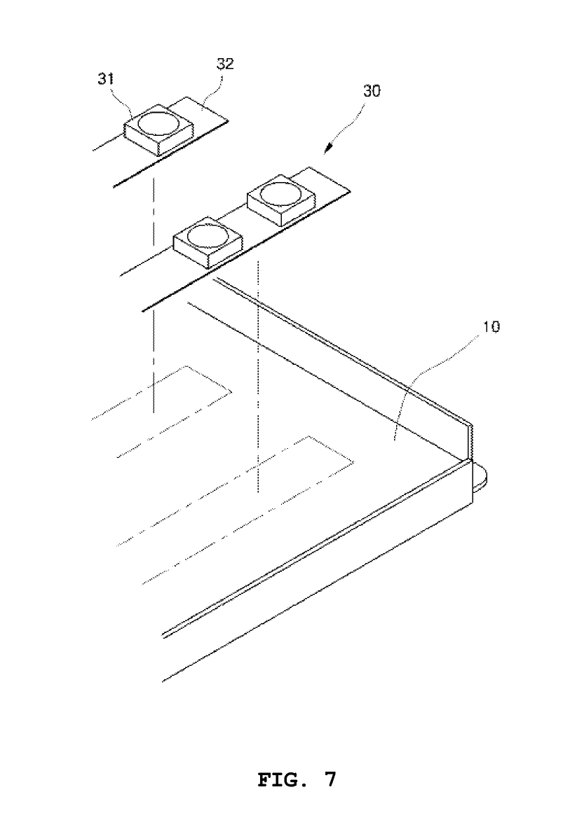

FIG. 7 is an enlarged perspective view of a fourth embodiment of the present invention.

Referring to the figure, a light source device according to the fourth embodiment proposes a construction which is employed when the light source is disposed directly below the backlight unit BLU. This construction is intended so that it can be more simply applied than the construction of the third embodiment.

For this, the light source device has the light source unit 30 which is directly coupled to the front surface of the rear cover 10. In the light source unit 30, the patterned substrates 32 are coupled to the rear cover 10 via taping such that a minimum distance through which heat from the LEDs 31 is dissipated to the outside can be maintained.

Like the light source device according to the third embodiment, the light source device according to the fourth embodiment may employ a single patterned substrate 32 on which a plurality of LEDs 31 are mounted in a plurality of columns and rows in place of the patterned substrates 32 arranged in the shape of a plurality of stripes. However, considering heat dissipation ability and compatibility with the backlight unit BLU which has the light source disposed directly below, the construction of the light source unit 30 having the patterned substrates 32 which are arranged in the shape of a plurality of stripes is more preferable than the construction of the light source unit 30 having the single patterned substrate 32.

1. A light source device of a backlight unit in which a circuit board on which light-emitting diodes are mounted is disposed inside a rear cover and a heat dissipating means for dissipating heat generated from the light-emitting diodes to an outside is disposed between the rear cover and the circuit board, wherein
the circuit board is implemented as a patterned substrate which includes a thin sheet and a conductive pattern formed on the thin sheet, the conductive pattern connecting the light-emitting diodes to a power source, thereby reducing a thickness through which the heat generated by the light-emitting diodes is to be conducted to the heat dissipating means.

2. A light source device of a backlight unit for a display in which a backlight unit (BLU) is disposed inside a rear cover, the light source device comprising:
a heat dissipation cover coupled to at least one open portion of the rear cover, the heat dissipation cove forming part of a case construction of the rear cover, and being exposed to an outside, thereby removing a thickness of the rear cover from a thickness through which heat is to be conducted; and
a light source unit coupled to an inner surface of the heat dissipation cover at the open portion of the rear cover in order to supply light to a lightguide plate (S) of the backlight unit (BLU), the light source unit comprising a patterned substrate and a plurality of light-emitting diodes mounted on the patterned substrate.

3. The light source device of claim 2, wherein the patterned substrate comprises a thin sheet and a conductive pattern formed on the thin sheet, the conductive pattern connecting the light-emitting diodes to a power source, thereby reducing a thickness through which the heat generated by the light-emitting diodes is to be conducted to the heat dissipation cover.

4. The light source device of claim 1, wherein the patterned substrate is separately manufactured and attached to the heat dissipation cover or is formed as a substrate layer of a paint which is applied as a coating on a surface of the heat dissipation cover.

5. The light source device of claim 1, wherein the patterned substrate comprises a heat conductive plastic which includes a synthetic resin composition and a material mixed to the synthetic resin composition to impart heat conduction ability.

6. The light source device of claim 2, wherein the heat dissipation cover forms a sidewall surface of the rear cover, and is applied to the backlight unit (BLU), the light source device being coupled to an edge the backlight unit (BLU).

7. The light source device of claim 2, wherein the heat dissipation cover comprises at least one section in front of the rear cover, and is applied to the backlight unit (BLU), the light source device being disposed directly below the backlight unit (BLU).

8. The light source device of claim 3, wherein the patterned substrate is separately manufactured and attached to the heat dissipation cover or is formed as a substrate layer of a paint which is applied as a coating on a surface of the heat dissipation cover.

9. The light source device of claim 3, wherein the patterned substrate comprises a heat conductive plastic which includes a synthetic resin composition and a material mixed to the synthetic resin composition to impart heat conduction ability.
